(19) United States
(12) Patent Application Publication
(10) Pub. No.: US 2025/0121679 A1
(43) Pub. Date: Apr. 17, 2025

(54) MOTOR VEHICLE TANK WITH EXTRACTION INSERT

(71) Applicants: MAGNA Energy Storage Systems USA LLC, Spartanburg, SC (US); MAGNA Energy Storage Systems GmbH Werk Schwäbisch Gmünd, Schwabisch Gmund (DE)

(72) Inventors: Alexander HIEBER, SPARTANBURG, SC (US); Harry WIESE, Moegglingen (DE); Steffen ZANEK, Schwäbisch Gmünd (DE)

(73) Assignees: MAGNA Energy Storage Systems USA LLC, Spartanburg, SC (US); MAGNA Energy Storage Systems GmbH Werk Schwäbisch Gmünd, Schwabisch Gmund (DE)

(21) Appl. No.: 18/485,267

(22) Filed: Oct. 11, 2023

(51) Int. Cl. B60K 15/035; B60K 15/03

(52) U.S. Cl. CPC B60K 15/035; B60K 2015/03032; B60K 2015/03217

(57) ABSTRACT

A motor vehicle tank including a fuel tank for storing a fuel and a withdrawal insert inserted at an opening in a wall of the fuel tank, and a method of manufacturing such a motor vehicle fuel tank. The motor vehicle tank includes a fuel tank for storing fuel, the fuel tank having a wall with an opening, a withdrawal insert member operable for inserting at the opening, and a flange plate fastened to the wall of the fuel tank in a region of the opening of the wall. The withdrawal insert member includes at least one supply line for withdrawing fuel from the fuel tank for a consumer, at least one return line for returning withdrawn fuel via the at least one supply line to the fuel tank, and a level sensor operable to determine a level of fuel in the fuel tank. The flange plate includes a flange plate opening in the region of the opening of the wall, with a thread of a bayonet fastener or a thread of a screw fastener on the end-face edge of the flange plate opening. The withdrawal insert member has a corresponding mating element for the thread of the flange plate opening for fastening to the flange plate via the bayonet catch or the screw fastener.

### TECHNICAL FIELD

One or more embodiments relate to a motor vehicle tank comprising a fuel tank for storing a fuel and a withdrawal insert inserted at an opening in a wall of the fuel tank, and a method of manufacturing such a motor vehicle fuel tank.

### BACKGROUND

It is known that a supply line can be used to withdraw fuel from a fuel tank, in particular, to supply the fuel to a consumer such as an internal combustion engine. Unused fuel can then be returned to the fuel tank via a return line.

It is also known that the fill level of a fuel tank is determined by a fill level sensor, for example in order to display the fill level on a display in the interior of the motor vehicle.

Level sensors, supply lines and return lines have sections that must be located inside the tank to access fuel stored there and also have sections that must be accessible outside the tank to conduct the fuel or to provide fluid or electrical signals outside the fuel tank. Therefore, it is known for such components to be mounted on the wall of a fuel tank in the form of an insert, in which case the wall of the fuel tank must have an opening for receiving the respective insert. In most cases, each of the aforementioned parts forms an independent, separate insert.

The problem here is that such a fuel tank is not very strong mechanically in the area of the inserts and that fixing the inserts during the production of the fuel tank is complex and therefore costly.

### SUMMARY

One or more embodiments provide an enhanced a motor vehicle tank of the type mentioned is provided, and, in particular, a motor vehicle tank which has a high mechanical strength and can be manufactured quickly and inexpensively, and a simple and inexpensive method for manufacturing such a motor vehicle tank.

In accordance with one or more embodiments, a motor vehicle tank comprises one or more of the following: a fuel tank for storing a fuel; and a withdrawal insert member which is inserted at an opening in a wall of the fuel tank, the withdrawal insert member comprising: (i) at least one supply line for withdrawing fuel from the fuel tank for a consumer, (ii) at least one return line for returning fuel withdrawn via the supply line to the fuel tank, and (iii) a level sensor for determining the level of the fuel in the fuel tank; a flange plate fastened to the wall of the fuel tank in the region of the opening of the wall of the fuel tank, the flange plate having a flange plate opening in the region of the opening of the wall, with a thread of a bayonet fastener or a thread of a screw fastener on the end-face edge of the flange plate opening, the withdrawal insert member having a corresponding mating element for the thread of the flange plate opening and being fastened to the flange plate via this bayonet catch or screw closure.

In accordance with one or more embodiments, an extraction insert, i.e., a withdrawal insert member, is used on a fuel tank which combines several functions and combines them in a single component, namely the determination of the fill level via a fill level sensor and the extraction and return of fuel via at least one supply line and one return line in each case. In accordance with one or more embodiments, the insert is designed to be fastened in a simple manner, via a bayonet lock or screw lock, to a flange plate which reinforces the fuel tank in the region of the opening for the withdrawal insert member. The flange plate covers the opening in the tank wall and preferably projects over the opening in the tank wall at all side edges. The flange plate itself has an opening substantially coincident with the opening of the wall of the tank, so that there is access to the interior of the fuel tank. The face of the opening of the flange plate, which extends over the height of the flange plate, is provided with a required element for a bayonet closure or a screw closure. The withdrawal insert member has a preferably cylindrical fastening area, which itself forms the required counter-element for the bayonet catch or screw cap. The withdrawal insert member can thus be joined to the fuel tank in a simple and cost-effective manner and the corresponding area of the fuel tank also has a desired mechanical strength.

In accordance with one or more embodiments, the withdrawal insert member is attached to the top of the fuel tank in the installation position. The supply line, the return line and/or the level sensor may thereby extend substantially vertically, from top to bottom, into the tank. “Top” and “bottom” here denote the usual orientations in a motor vehicle when the motor vehicle tank is installed. For example, fuel returned via the return line can thereby fall into the tank due to the effect of gravity.

In accordance with one or more embodiments, the supply line, the return line, and the level sensor are routed through the opening in the wall of the fuel tank and the flange plate opening, so that they are formed at least partially inside the fuel tank and have at least one access outside the fuel tank. The access can be, for example, an access for a fluid flow or an electrical and/or signaling access.

In accordance with one or more embodiments, the inlets of the supply line, the return line and the level sensor are preferably formed in a head part of the sampling insert outside the fuel tank. The sampling insert can thus have a preferably cylindrical head part outside the fuel tank and a preferably cylindrical fastening area for the bayonet or screw connection to the fuel tank.

In accordance with one or more embodiments, at least the supply line, and preferably also the return line and/or the level sensor, extends essentially through the entire fuel tank and has a mouth or a free end inside the fuel tank near the bottom of the fuel tank.

In accordance with one or more embodiments, in addition to the supply line, return line and level sensor, the tapping insert can have a vent valve.

In accordance with one or more embodiments, a flat surface is formed in the flange plate in certain areas, preferably by forming, for example by stamping. The flange plate opening is preferably located completely in the flat surface.

In accordance with one or more embodiments, the flat face is outwardly offset from the rest of the flange plate. In another embodiment, the flat surface is offset inward relative to the rest of the flange plate.

In accordance with one or more embodiments, the flat surface is substantially circular, as is the opening in the tank wall and the opening in the flange plate. The flange plate preferably has a substantially oval, elliptical, rectangular, trapezoidal, or diamond shape cross-section, or configuration.

In accordance with one or more embodiments, a method for manufacturing a motor vehicle tank comprises one or more of the following: manufacturing a fuel tank with the opening in the wall, the fuel tank operable for storing fuel; fastening (e.g., via welding and/or mechanical fastening) a flange plate with a flange plate opening in the area of the opening of the wall of the fuel tank to the wall of the fuel tank; inserting a withdrawal insert member in the opening in the wall of the fuel tank and the flange plate opening, and then fastening (e.g., mechanical fastening) the withdrawal insert member to the end edge of the flange plate opening via a thread of the bayonet lock or a thread of a screw lock.

### DRAWINGS

One or more embodiments will be illustrated by way of example in the drawings and explained in the description hereinbelow.

FIG. 1 illustrates a perspective schematic representation of a motor vehicle tank according to the invention, with inserted withdrawal insert member.

FIG. 2 illustrates a detailed representation of the motor vehicle tank of FIG. 1 in the area of the flange plate, without the withdrawal insert member.

### DESCRIPTION

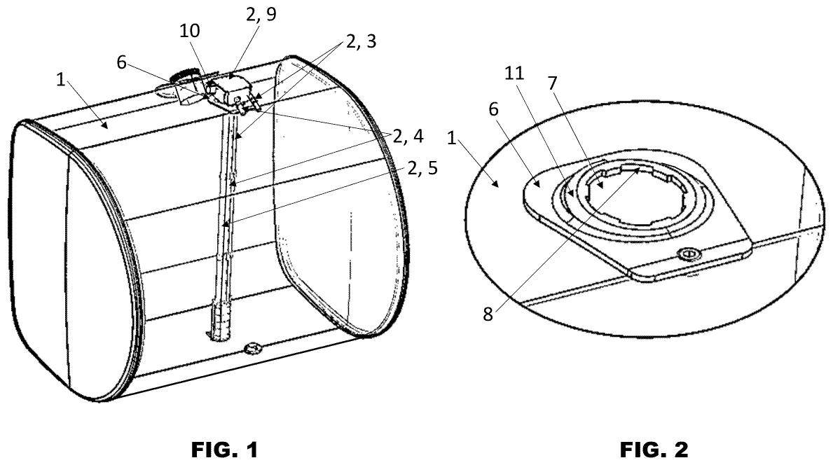

FIG. 1 shows a motor vehicle tank in accordance with one or more embodiments, comprising a fuel tank 1, for example at least approximately cylindrical, for storing a fuel, such as diesel, and a withdrawal insert member 2, i.e., an extraction insert which is inserted at an opening in a wall, namely in the shell of the fuel tank 1.

The withdrawal insert member 2 comprises a supply line 3 for withdrawing fuel from the fuel tank 1 for a consumer, a return line 4 for returning fuel previously withdrawn via the supply line 3 to the fuel tank 1, and a level sensor 5 for determining the level of the fuel in the fuel tank 1.

As illustrated in FIG. 2, a flange plate 6 is attached to the wall of the fuel tank 1 in the area of the opening of the wall of the fuel tank 1. The flange plate 6 also has an opening in the region of the opening of the wall, namely a substantially round bore, as a flange plate opening 7. A thread 8 of a bayonet catch is formed at the end edge of the flange plate opening 7, so that the withdrawal insert member 2, which has a corresponding mating element for the thread 8 of the flange plate opening 7, is fastened to the flange plate 7 via this bayonet catch illustrated in FIG. 1 and can be fastened in the state illustrated in FIG. 2.

The withdrawal insert member 2 is attached to the top of the fuel tank 1 in the installed position. The supply line 3, the return line 4 and the level sensor 5 are routed through the opening in the wall of the fuel tank 1 and the flange plate opening 7 so that they extend into the fuel tank 1 and are largely formed inside the fuel tank 1. Each of these functional components of the extraction insert 2 has an access outside the fuel tank 1.

The accesses to the supply line 3 and the return line 4 are formed in a head part 9 of the extraction insert 2, outside the fuel tank 1. The accesses to the supply line 3 and return line 4 of the withdrawal insert member 2 can have connection pieces for the connection of suitable lines.

The supply line 3, the return line 4 and the level sensor 5 run essentially through the entire fuel tank 1. A mouth or a free end of the respective lines or the sensor are located near the bottom of the fuel tank 1.

In addition, the withdrawal insert member 2 has a vent valve 10 in the head part 9.

The flange plate 6 has a substantially round flat surface 11. The likewise round flange plate opening 7 is formed in the flat surface 11. A flat withdrawal insert member 2 and/or a flat seal can be seated tightly against the flat surface 11 in a simple manner relative to the flange plate. The flat surface 11 is offset outwardly relative to the rest of the flange plate 6, in particular by outward forming.

The terms “coupled,” “attached,” or “connected” may be used herein to refer to any type of relationship, direct or indirect, between the components in question, and may apply to electrical, mechanical, fluid, optical, electromagnetic, electromechanical, or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

1 Fuel tank
2 Withdrawal insert member
3 Supply line
4 Return line
5 Level sensor
6 Flange plate
7 Flange plate opening
8 Thread of flange plate opening
9 Head part
10 Vent valve
11 Flat surface

What is claimed is:

1. A motor vehicle tank, comprising:
a fuel tank for storing fuel, the fuel tank having a wall with an opening;
a withdrawal insert member operable for inserting at the opening, the withdrawal insert member including:
at least one supply line for withdrawing fuel from the fuel tank for a consumer,
at least one return line for returning withdrawn fuel via the at least one supply line to the fuel tank, and
a level sensor operable to determine a level of fuel in the fuel tank;
a flange plate fastened to the wall of the fuel tank in a region of the opening of the wall, the flange plate including a flange plate opening in the region of the opening of the wall, with a thread of a bayonet fastener or a thread of a screw fastener on the end-face edge of the flange plate opening,
wherein the withdrawal insert member has a corresponding mating element for the thread of the flange plate opening for fastening to the flange plate via the bayonet catch or the screw fastener.

2. The motor vehicle tank of claim 1, wherein the withdrawal insert member is operable for fastening to a top of the fuel tank in an installed position.

3. The motor vehicle tank of claim 1, wherein the at least one supply line, the at least one return line, and the level sensor are guided through the opening in the wall of the fuel tank and the flange plate opening so that they are formed at least partially inside the fuel tank and have at least one access outside of the fuel tank.

4. The motor vehicle tank of claim 1, wherein the at least one supply line includes a supply line inlet formed in a head part of the withdrawal insert member outside of the fuel tank.

5. The motor vehicle tank of claim 4, wherein the at least one return line includes a return line inlet formed in the head part of the withdrawal insert member outside of the fuel tank.

6. The motor vehicle tank of claim 5, wherein the level sensor includes a level sensor inlet formed in the head part of the withdrawal insert member outside of the fuel tank.

7. The motor vehicle tank of claim 1, wherein at least the at least one supply line extends through the entire fuel tank and has a supply line opening adjacent to a bottom surface of the fuel tank.

8. The motor vehicle tank of claim 1, wherein at least the at least one return line extends through the entire fuel tank and has a return line opening adjacent to a bottom surface of the fuel tank.

9. The motor vehicle tank of claim 1, wherein at least the level sensor extends through the entire fuel tank and has a level sensor opening adjacent to a bottom surface of the fuel tank.

10. The motor vehicle tank of claim 1, wherein the withdrawal insert member further includes a vent valve.

11. The motor vehicle tank of claim 1, wherein certain regions of the flange plate has a flat surface formed therein.

12. The motor vehicle tank of claim 11, wherein the flange plate opening lies completely in the flat surface.

13. The motor vehicle tank of claim 12, wherein the flat surface is outwardly offset or inwardly offset from the remaining regions of the flange plate.

14. The motor vehicle tank of claim 12, where the flat surface has a circular configuration.

15. A method for manufacturing the motor vehicle tank of claim 1, the method comprising:
manufacturing the fuel tank with the opening in the wall, the fuel tank operable for storing fuel;
fastening the flange plate with the flange plate opening in the area of the opening of the wall of the fuel tank to the wall of the fuel tank;
inserting the withdrawal insert member in the opening in the wall of the fuel tank and the flange plate opening; and
fastening the withdrawal insert member to an end edge of the flange plate opening via the thread of the bayonet lock or the thread of the screw fastener.

16. The method of claim 15, wherein fastening the withdrawal insert member comprises fastening the withdrawal insert member to a top of the fuel tank in an installed position.

17. The method of claim 15, further comprising guiding the at least one supply line, the at least one return line, and the level sensor through the opening in the wall of the fuel tank and the flange plate opening so that they are formed at least partially inside the fuel tank and have at least one access outside of the fuel tank.

18. The method of claim 15, wherein the at least one supply line includes a supply line inlet formed in a head part of the withdrawal insert member outside of the fuel tank.

19. The method of claim 18, wherein the at least one return line includes a return line inlet formed in the head part of the withdrawal insert member outside of the fuel tank.

20. The method of claim 19, wherein the level sensor includes a level sensor inlet formed in the head part of the withdrawal insert member outside of the fuel tank.
